(19) United States
(12) Patent Application Publication
(10) Pub. No.: US 2013/0263163 A1
(43) Pub. Date: Oct. 3, 2013

(54) EMERGENCY EJECTION PROTECTING MODULE FOR AN OPTICAL DISC DRIVE

(71) Applicant: QUANTA STORAGE INC., Taoyuan County (TW)

(72) Inventors: Yao-Ting Kuo, Taoyuan County (TW); Ko-Han Huang, Taoyuan County (TW); Jen-Chen Wu, Taoyuan County (TW)

(73) Assignee: QUANTA STORAGE INC., Taoyuan County (TW)

(21) Appl. No.: 13/650,101

(22) Filed: Oct. 11, 2012

(30) Foreign Application Priority Data
Mar. 31, 2012 (CN) 201210093238.4

(51) Int. Cl. G11B 17/051

(52) U.S. Cl. 720/626; G9B/17.032

(57) ABSTRACT

An emergency ejection protecting module is disclosed to protect the emergency ejection device in an optical disc drive. When the optical disc drive reads/writes a disc, moving a protection door at the case to reveal an ejection hole causes an abnormal operation of the emergency ejection. The contact end protruded from the protection door activates a sensor to transmit an ejection signal to the optical disc drive, and the optical disc drive starts the ejection operation to protect the disc.

### BACKGROUND OF THE INVENTION

1. Field of the Invention

The present invention relates to an emergency ejection protecting module, and more specifically, to an emergency ejection protecting module for an optical disc drive activated manually to eject a disc when a power failure occurs or the optical disc drive is broken.

2. Description of the Prior Art

An optical disc drive cannot eject a disc automatically when a power failure occurs or the optical disc drive is broken. Therefore, the optical disc drive usually has an emergency ejection device for facilitating consumers to eject the disc manually without disassembling an external case of the optical disc drive, so as to increase the convenience of the optical disc drive.

Please refer to FIG. 1, FIG. 1 is a diagram of an optical disc drive 10 disclosed in U.S. Pat. No. 7,698,715 in the prior art. When the optical disc drive 10 is to eject an disc 13, an ejection button 11 disposed at a front end of the optical disc drive 10 is pressed, and the optical disc drive 10 receives an ejection signal produced by the ejection button 11 to cut off power of a spindle motor 12 immediately. Therefore, the disc 13 clipped by the spindle motor 12 stops rotating, and then the disc 13 is ejected from the optical disc drive 10 for easily being taken by consumers. However, when a power failure occurs or the optical disc drive 10 is broken, the ejection button 11 cannot operate normally, and it only can use a rod 14, such as a paper clip, to plug into an ejection hole 15 disposed at the front end of the optical disc drive 10, so as to activate the emergency ejection device manually to unlock a self-locking transmission mechanism 16 to eject the disc 13.

However, the rod 14 can plug into the ejection hole 15 of the optical disc drive 10 anytime, so that the emergency ejection device cannot prevent from being activated improperly when the optical disc drive 13 is still reading or writing. Once the emergency ejection device is activated improperly, the rotating disc 13 with high speed will contact inner components inside the optical disc drive 10 and the disc 13 will be damaged or broken, even broken out to hurt users. Therefore, there are problems to be solved about the emergency ejection device of the optical disc drive.

### SUMMARY OF THE INVENTION

A purpose of the present invention is to provide an emergency ejection protecting module with a protection door to shade an ejection hole to prevent an emergency ejection device from being activated improperly.

Another purpose of the present invention is to provide the emergency ejection protecting module with a sensor to sense that the protection door is not opened properly, so as to transmit an ejection signal to the optical disc drive immediately, for activating an ejecting operation to prevent the disc from being damaged.

In order to achieve the above purposes, the emergency ejection protecting module includes an ejection hole on a sliding slot of a case. A protection door with a contact end is slidably installed inside the sliding slot to shade or reveal the ejection hole. The contact end activates a sensor to transmit an ejection signal. An emergency ejection device is disposed inside the optical disc drive and located in a position on an extension line of the ejection hole. A disc can be ejected manually. When the optical disc drive reads the disc and the protection door is moved to reveal the ejection hole, the contact end moves with the protection door to activate the sensor, so as to transmit the ejection signal to the optical disc drive to stop rotating the disc and to eject the disc automatically.

When the optical disc drive is in normal operation, the protection door is in a position to shade the ejection hole, and the contact end presses the sensor, so that the sensor does not transmit the ejection signal to the optical disc drive. And when the optical disc drive detects that the contact end keeps pressing the sensor in order to ensure the protection door shades the ejection hole, the optical disc drive restores to normal operation. Besides, when the optical disc drive is broken down, the protection door is moved to reveal the ejection hole, and the sensor does not transmit the ejection signal. Therefore it is needed to activate the emergency ejection device via the ejection hole. The emergency ejection device includes a transmission motor for rotating a self-locking worm gear to drive a first transmission gear and a second transmission gear. And a clutch gear is linked to the first transmission gear for transmitting or cutting off power from the first transmission gear to the second transmission gear. The emergency ejection device further includes a ratchet connected to the second transmission gear for rotating the second transmission gear in an ejecting direction. The emergency ejection device further includes a rack for driving the ratchet. The emergency ejection device further includes a returning spring for returning the rack after the rack drives the ratchet. The emergency ejection device further includes a sliding board whereon a fixing groove is formed for fixing the clutch gear. An inclined surface is formed at an end of the sliding board, and the inclined surface is between the rack and the ejection hole. The emergency ejection device further includes a positioning spring for returning the sliding board after the sliding board slides obliquely to drive the clutch gear.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an optical disc drive in the prior art.

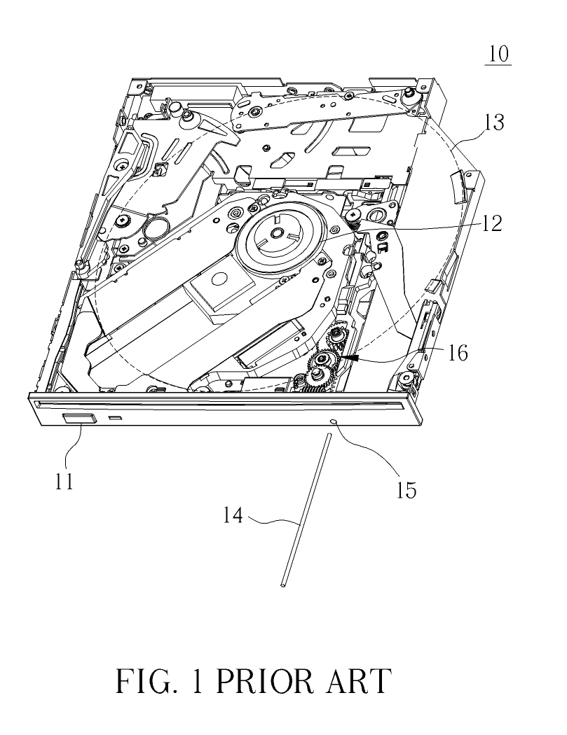

FIG. 2 is a top view of an emergency ejection device according to an embodiment of the present invention.

FIG. 3 is a partly enlarged drawing of part A illustrated in FIG. 2 according to the embodiment of the present invention.

FIG. 4 illustrates a clutch gear separating from a second transmission gear according to the embodiment of the present invention.

FIG. 5 is a partly enlarged drawing of part B illustrated in FIG. 4 according to the embodiment of the present invention.

FIG. 6 illustrates a rod activating an ejecting mechanism according to the embodiment of the present invention.

### DETAILED DESCRIPTION

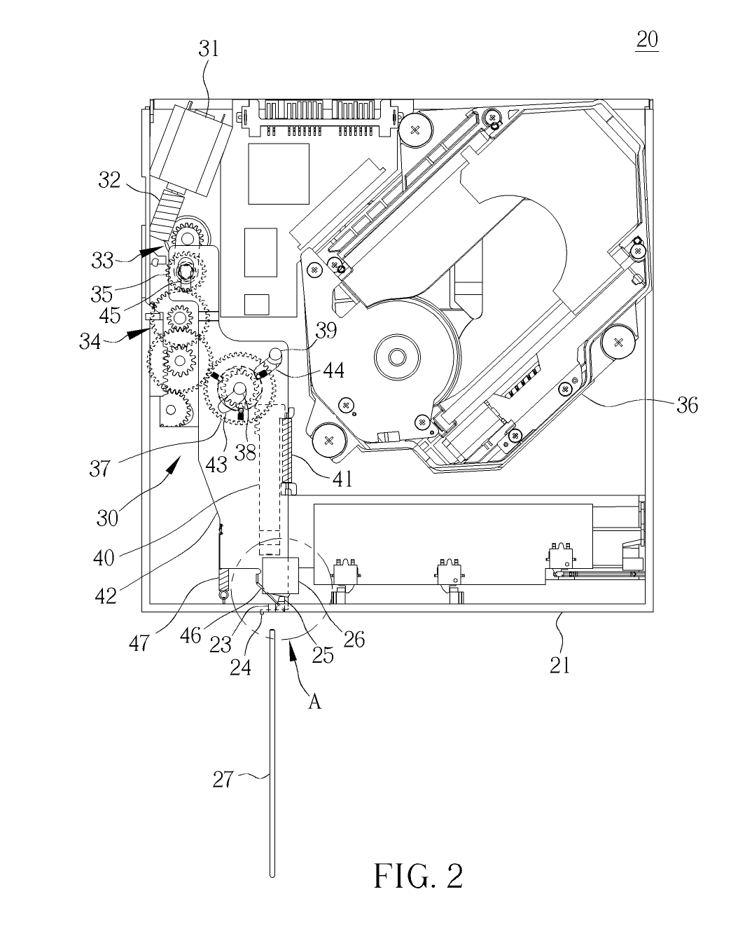

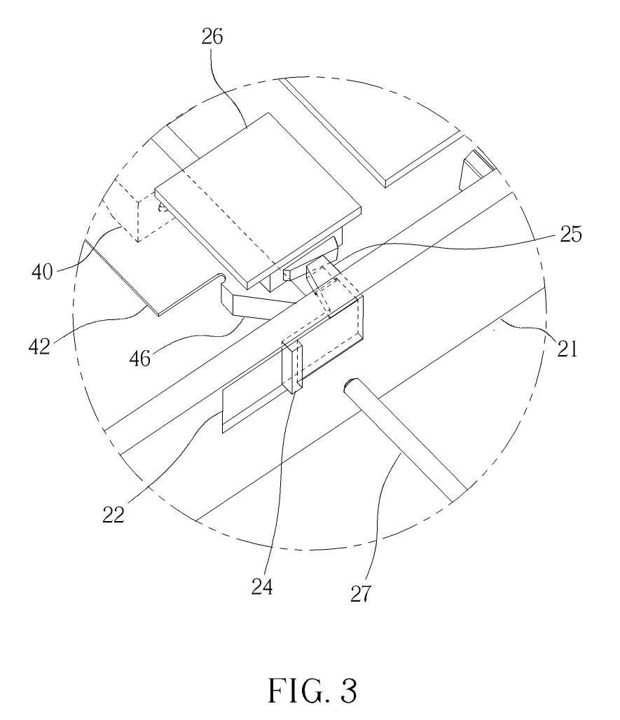

Please refer to FIG. 2 and FIG. 3. FIG. 2 is a top view of an emergency ejection device according to an embodiment of the present invention. FIG. 3 is a partly enlarged drawing of part A illustrated in FIG. 2 according to the embodiment of the present invention. The emergency ejection protecting module includes a case 21 of an optical disc drive 20, and a sliding slot 22 is formed on the case 21. An ejection hole 23 is disposed on the sliding slot 22. The emergency ejection protecting module further includes a protection door 24 slidably installed inside the sliding slot 22 to shade or reveal the ejection hole 23, and the protection door 24 includes a contact end 25 protruding toward an inner of the optical disc drive 20. The emergency ejection protecting module further includes a sensor 26 disposed on a travelling path of the contact end 25, and the sensor 26 can be activated by the contact end 25 to transmit an ejection signal to the optical disc drive 20 as pressing a conventional ejection button. The emergency ejection protecting module further includes an emergency ejection device 30 disposed inside the optical disc drive 20 and located in a position corresponding to the ejection hole 23. The position can be located on an extension line of the ejection hole 23. The emergency ejection device 30 can be activated manually to eject a disc. When it is needed to eject the disc manually, a rod 27 can be used to insert through the ejection hole 23 to the inner of the optical disc drive 20, so as to push the emergency ejection device 30 behind the ejection hole 23 to eject the disc.

A following embodiment of the emergency ejection device 30 is only an example for describing operation of the emergency ejection protecting module. The emergency ejection protecting module is implemented for the following embodiment of the emergency ejection device 30. Every emergency ejection device with the ejection hole 23 can be applied to the present invention.

The emergency ejection device 30 includes a transmission motor 31 for providing power. The transmission motor 31 is for rotating a self-locking worm gear 32 to drive a first transmission gear 33 and a second transmission gear 34. A clutch gear 35 is linked to the first transmission gear 33 for transmitting or cutting off power from the first transmission gear 33 to the second transmission gear 34. The second transmission gear 34 receives the power to drive a loading and unloading mechanism to load or unload the disc (not shown in figures), and to drive a traverse 36 to rotate or separate the disc (not shown in figures). The loading and unloading mechanism and the traverse 36 are known, and therefore detailed description about them is omitted herein.

The emergency ejection device 30 further includes a ratchet 37 connected to the second transmission gear 34 for rotating the second transmission gear 34 in an ejecting direction. A first guiding pin 38 is disposed on an axis of the ratchet 37, and a second guiding pin 39 is disposed near the ratchet 37 obliquely. The emergency ejection device 30 further includes a rack 40 slidably aligned to the extension line of the ejection hole 23 for driving the ratchet 37. The emergency ejection device 30 further includes a returning spring 41 for returning the rack 40 after the rack 40 drives the ratchet 37. An end of the returning spring 41 is fixed on the rack 40, and the other end of the returning spring 41 is fixed on the case 21. The emergency ejection device 30 further includes a sliding board 42. And a first inclined guiding groove 43, a second inclined guiding groove 44 and a fixing groove 45 are disposed on the sliding board 42. The first inclined guiding groove 43 and the second inclined guiding groove 44 respectively engage with the first guiding pin 38 and the second guiding pin 39, and the fixing groove 45 engages with the clutch gear 35. The sliding board 42 is obliquely moved along with the first guiding pin 38 and the second guiding pin 39, so as to drive the clutch gear 35 to move. An inclined surface 46 is formed at an end of the sliding board 42, and the inclined surface 46 is located on the extension line of the ejection hole 23 and between the rack 40 and the ejection hole 23. The emergency ejection device 30 further includes a positioning spring 47 for returning the sliding board 42 after the sliding board 42 slides obliquely to drive the clutch gear 35. An end of the positioning spring 47 is fixed on the sliding board 42, and the other end of the positioning spring 47 is fixed on the case 21.

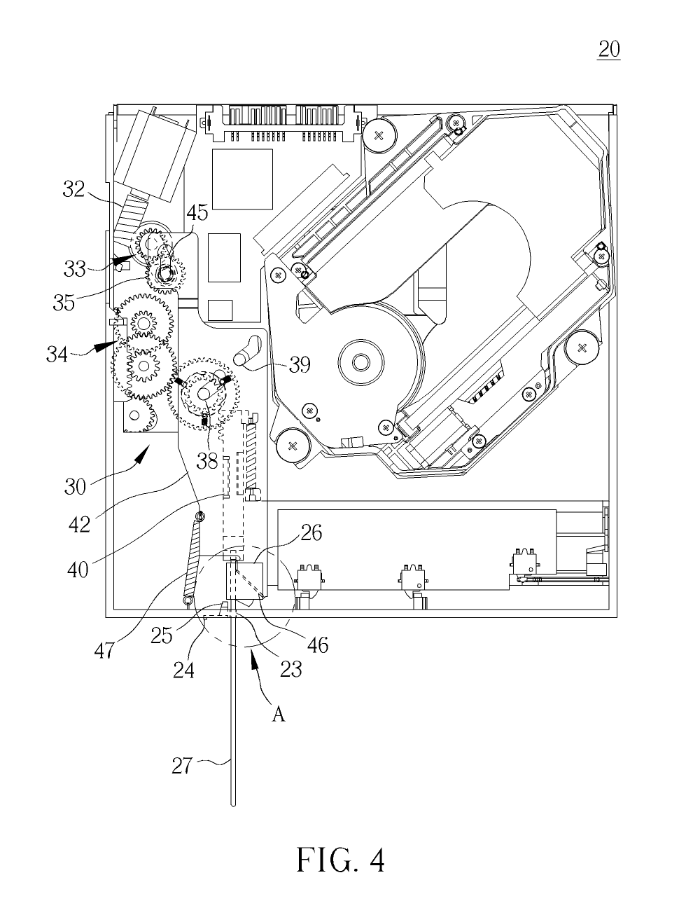

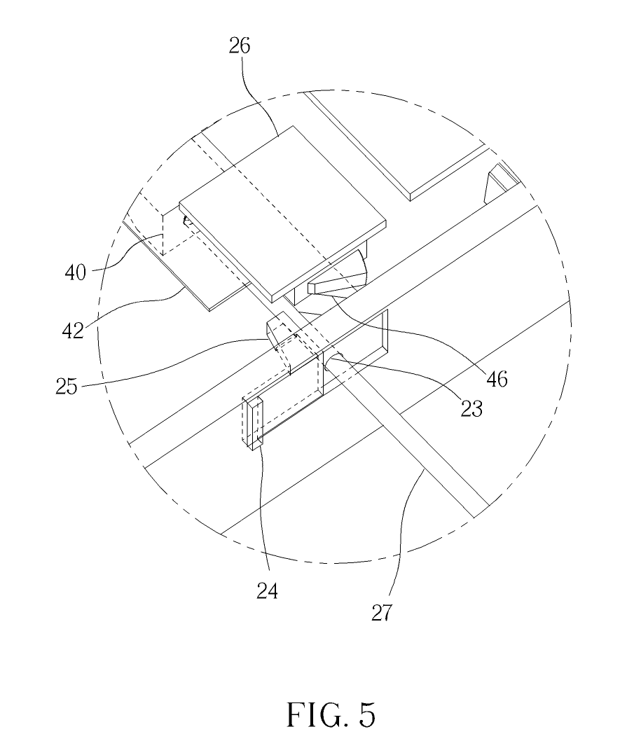

About operation of the emergency ejection device 30 will be described as follows. When the optical disc drive 20 is in normal operation, the protection door 24 is in a position to shade the ejection hole 23, and the contact end 25 presses the sensor 26, so that the sensor 26 does not transmit the ejection signal to the optical disc drive 20. Please refer to FIG. 4 and FIG. 5. FIG. 4 illustrates the clutch gear 35 separating from the second transmission gear 34 according to the embodiment of the present invention. FIG. 5 is a partly enlarged drawing of part B illustrated in FIG. 4 according to the embodiment of the present invention. When the optical disc drive reads the disc and the emergency ejection device 30 is operated improperly, the protection door 24 is moved to reveal the ejection hole 23, and then the contact end 25 is moved with the protection door 24 to separate from the sensor 26. As a result, the sensor 26 transmits the ejection signal to the optical disc drive 20 to stop rotating the disc and ejecting the disc automatically, even though users inserts the rod 27 into the ejection hole 23, it would not damage the ejected disc. After that, the optical disc drive 20 restores to normal operation when the optical disc drive 20 detects that the contact end 25 keeps pressing the sensor 26 in order to ensure the protection door 24 shades the ejection hole 23.

When a power failure occurs or the optical disc drive 20 is broken, the protection door 24 is moved to reveal the ejection hole 23 and the contact end 25 is moved with the protection door 24 to separate from the sensor 26. But the optical disc drive 20 does not work normally, and the sensor 26 cannot transmit the ejection signal to the optical disc drive 20 as usual. Next, the rod 27 can be used to insert through the ejection hole 23 to contact the inclined surface 46 of the sliding board 42 between the rack 40 and the ejection hole 23. The rod 27 is moved along the inclined surface 46 and resists a resilient force of the positioning spring 47, so as to drive the sliding board 42 to move along with the first guiding pin 38 and the second guiding pin 39 obliquely. And then, the rod 27 contacts against an edge of the inclined surface 46 to contact the rack 40 and constrain the sliding board 42 laterally. By the fixing groove 45 of the sliding board 42, the sliding board 42 slides obliquely to separate the clutch gear 35 from the second transmission gear 34, so as to release the second transmission gear 34 from the self-locking worm gear 32 and the first transmission gear 33. Therefore the clutch gear 35 can rotate freely. The disc is ejected by the rod 27 inserting through the ejection hole 23 to activate the emergency ejection device 30.

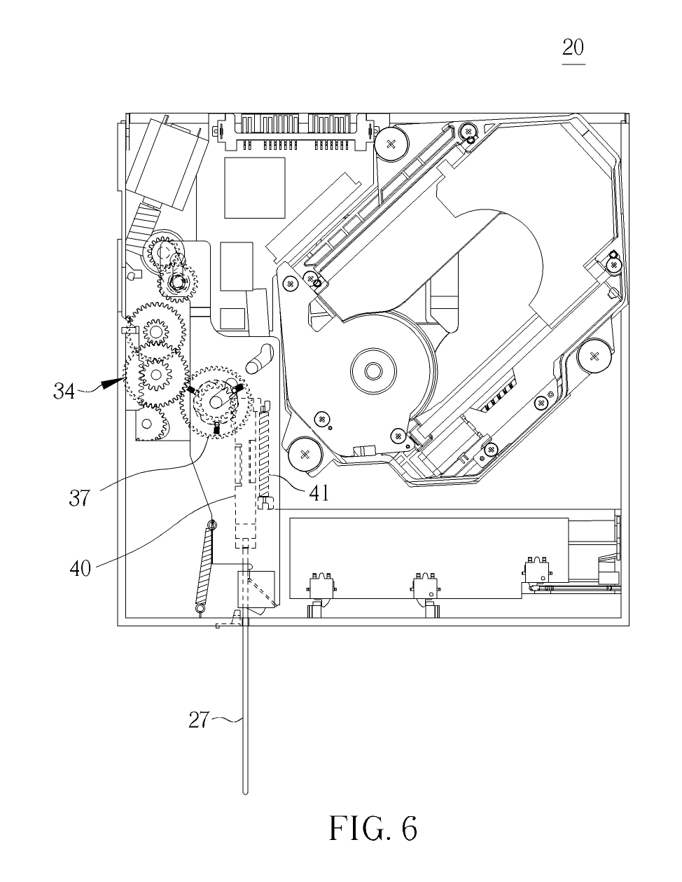

Please refer to FIG. 6. FIG. 6 illustrates the rod 27 activating the ejecting mechanism according to the embodiment of the present invention. When the rod 27 resists the resilient force of the returning spring 41 and keeps pushing the rack 40, the rack 40 rotates the ratchet 37 to drive the non-self-locking second transmission gear 34 to eject the disc. When the rod 27 is drawn out, the rack 40 is returned by the resilient restoring force of the returning spring 41 and drives the ratchet 37 reversely. Because the ratchet 37 only can rotate in a single direction, the ratchet 37 does not rotate the second transmission gear 34, so that the optical disc drive 20 can keep in an ejecting state to eject the disc. The operation of the ratchet 37 rotating the rack 40 depends on practical design. For example, a slot-in optical disc drive with a guide bar in the prior art needs to push the rack 40 in one to three times to eject the disc. Besides, it is needed to push the rack 40 in multiple times for a slot-in optical disc drive with a roller to eject the disc. Please refer to FIG. 3 again, after emergency ejection has been finished, the optical disc drive 20 restores to normal operation only when the optical disc drive 20 detects that the contact end 25 keeps pressing the sensor in order to ensure the protection door 24 shades the ejection hole 23.

Therefore, the emergency ejection protecting module of the present invention can protect the emergency ejection device 30 by disposing the protection door 24 to shade or reveal the ejection hole 23, and transmit the ejection signal to the optical disc drive 20 by the sensor 26 detecting the protection door 24 activated improperly, so as to eject the disc to prevent the disc from being damaged due to improper activation of the emergency ejection device 30.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An emergency ejection protecting module for an optical disc drive, comprising:
a case whereon a sliding slot is formed, and an ejection hole being disposed on the sliding slot;
a protection door slidably installed inside the sliding slot to shade or reveal the ejection hole, the protection door comprising a contact end protruding toward an inner of the optical disc drive;
a sensor disposed on a travelling path of the contact end, and the sensor being activated by the contact end to transmit an ejection signal to the optical disc drive; and
an emergency ejection device disposed inside the optical disc drive and located in a position corresponding to the ejection hole, the emergency ejection device being activated manually to eject a disc, wherein when the optical disc drive reads the disc and the protection door is moved to reveal the ejection hole, the contact end moves with the protection door to activate the sensor, so as to transmit the ejection signal to the optical disc drive to eject the disc.

2. The emergency ejection protecting module of claim 1, wherein when the optical disc drive is in normal operation, the protection door is in a position to shade the ejection hole, and the contact end presses the sensor, so that the sensor does not transmit the ejection signal to the optical disc drive.

3. The emergency ejection protecting module of claim 1, wherein the optical disc drive stops rotating the disc and ejecting the disc as receiving the ejection signal.

4. The emergency ejection protecting module of claim 1, wherein the optical disc drive restores to normal operation when the optical disc drive detects that the contact end keeps pressing the sensor in order to ensure the protection door shades the ejection hole.

5. The emergency ejection protecting module of claim 1, wherein as the optical disc drive is broken down and the protection door is moved to reveal the ejection hole, the contact end is moved to separate from the sensor and the sensor does not transmit the ejection signal to the optical disc drive, and the disc is ejected by a rod inserting through the ejection hole to activate the emergency ejection device.

6. The emergency ejection protecting module of claim 1, wherein the emergency ejection device comprises:
a transmission motor for rotating a self-locking worm gear to drive a first transmission gear and a second transmission gear, a clutch gear being linked to the first transmission gear for transmitting or cutting off power from the first transmission gear to the second transmission gear;
a ratchet connected to the second transmission gear for rotating the second transmission gear in an ejecting direction;
a rack slidably aligned to the ejection hole for driving the ratchet;
a returning spring for returning the rack after the rack drives the ratchet, an end of the returning spring being fixed on the rack and the other end of the returning spring being fixed on the case;
a sliding board whereon a fixing groove is formed for fixing the clutch gear, an inclined surface being formed at an end of the sliding board, the inclined surface being located corresponding to the ejection hole and between the rack and the ejection hole; and
a positioning spring for returning the sliding board after the sliding board slides obliquely to drive the clutch gear, an end of the positioning spring being fixed on the sliding board and the other end of the positioning spring being fixed on the case.

7. The emergency ejection protecting module of claim 6, wherein the emergency ejection device further comprises a first guiding pin disposed on an axis of the ratchet and a second guiding pin disposed near the ratchet, a first inclined guiding groove and a second inclined guiding groove are disposed on the sliding board, and the first inclined guiding groove and the second inclined guiding groove respectively engage with the first guiding pin and the second guiding pin, so as to guide the sliding board to slide obliquely.

8. The emergency ejection protecting module of claim 6, wherein the sliding board slides obliquely to separate the clutch gear from the second transmission gear, so as to release the second transmission gear.
